(19) United States
(12) Patent Application Publication
(10) Pub. No.: US 2025/0350169 A1
(43) Pub. Date: Nov. 13, 2025

(54) MOTOR STRUCTURE

(71) Applicant: DELTA ELECTRONICS, INC., Taoyuan City (TW)

(72) Inventors: Wan-Bao SHEN, Taoyuan City (TW); Chih-Wei LIN, Taoyuan City (TW); Chia-Feng WU, Taoyuan City (TW)

(21) Appl. No.: 18/792,577

(22) Filed: Aug. 2, 2024

(30) Foreign Application Priority Data
May 8, 2024 (CN) 202410560591.1

(51) Int. Cl. H02K 9/06; H02K 5/18; H02K 5/20; H02K 21/16

(52) U.S. Cl. CPC H02K 9/06; H02K 5/18; H02K 5/207; H02K 21/16

(57) ABSTRACT

A motor structure includes a stator ring, a rotor, a wind blade set and a thermally-conductive casing. The stator ring has a rotor accommodation space located therein. The rotor is located in the rotor accommodation space. The wind blade set is arranged at one side of the rotor. The thermally-conductive casing encloses the stator ring, rotor and wind blade set. The thermally-conductive casing includes a thermally-conductive cover, and the thermally-conductive cover has a plurality of radially-inner holes and a plurality of radially-outer holes.

### CROSS-REFERENCE TO RELATED APPLICATION

This application claims priority to China Application Serial Number 202410560591.1, filed May 8, 2024, which is herein incorporated by reference in its entirety.

### BACKGROUND

### Field of Disclosure

The present disclosure relates to a motor structure, and more particularly to the motor structure with active cooling function.

### Description of Related Art

Motors are components used to convert electrical energy into mechanical energy and have been widely used in daily life. The stator or rotor inside the motor usually has a copper conductor coil. The copper conductor has a certain resistance. Therefore, when the electricity is energized, some electrical energy will be lost due to resistance and dissipated in the form of heat energy, which may damage the enameled film and affect the motor's life span.

Conventional motors usually have a passive heat dissipation function. However, when the power of the motor gradually increases, the passive heat dissipation function is often unable to meet the heat energy generated when the high-power motor operates.

### SUMMARY

The present disclosure provides an improved motor structure to deal with the needs of the prior art problems.

In one or more embodiments, a motor structure including: a stator ring with a rotor accommodation space; a rotor located within the rotor accommodation space; a wind blade set located on one side of the rotor; and a thermally-conductive casing enclosing the stator ring, the rotor and the wind blade set, wherein the thermally-conductive casing includes a thermally-conductive cover having a plurality of radially-inner holes and a plurality of radially-outer holes.

In one or more embodiments, the radially-inner holes are axially aligned with the wind blade set.

In one or more embodiments, the thermally-conductive cover includes a flow-blocking ring located between the radially-inner holes and the radially-outer holes.

In one or more embodiments, the wind blade set includes a plurality of blades, and a radial length of each blade is smaller than a radius of the flow-blocking ring.

In one or more embodiments, each radially-inner hole is radially located between two immediately-adjacent ones of the radially-outer holes, and each radially-outer hole is radially located between two immediately-adjacent ones of radially-inner holes.

In one or more embodiments, each radially-outer hole is axially aligned with a corresponding coil of the stator ring.

In one or more embodiments, each radially-outer hole is axially aligned with portions of two corresponding coils of the stator ring and a gap between the two corresponding coils.

In one or more embodiments, the thermally-conductive casing includes another thermally-conductive cover, and the another thermally-conductive cover includes a plurality of heat dissipation fins.

In one or more embodiments, a motor structure including: a stator ring with a rotor accommodation space; a rotor located in the rotor accommodation space; two wind blade sets located on two opposite sides of the rotor; and two thermally-conductive covers are assembled to form a thermally-conductive casing to enclose the stator ring, the rotor and the two wind blade sets, wherein each thermally-conductive cover has a plurality of radially-inner holes and a plurality of radially-outer holes.

In one or more embodiments, the radially-inner holes are axially aligned with the two wind blade sets, and the radially-outer holes are axially aligned with corresponding coils of the stator ring.

In one or more embodiments, each thermally-conductive cover includes a flow-blocking ring located between the radially-inner holes and the radially-outer holes.

In one or more embodiments, each wind blade set includes a plurality of blades, and a radial length of each blade is smaller than a radius of the flow-blocking ring.

In one or more embodiments, each wind blade set includes a plurality of radially-inner blades and a plurality of radially-outer blades, and radial lengths of all the radially-inner blades and the radially-outer blades are smaller than a radius of the flow-blocking ring.

In one or more embodiments, each radially-inner hole is radially located between two immediately-adjacent ones of the radially-outer holes, and each radially-outer hole is radially located between two immediately-adjacent ones of radially-inner holes.

In one or more embodiments, each radially-outer hole is axially aligned with portions of two corresponding coils of the stator ring and a gap between the two corresponding coil.

In sum, the motor structure disclosed here is configured with a wind blade set on the rotor, which induces airflow in the thermally-conductive casing to enhance heat dissipation. At least one of the thermal conductive covers of the thermal-conductive casing can be configured with a radially-inner hole and a radially-outer hole, such that the airflows in and out of the thermally-conductive cover can be smoother, reducing turbulence and improving heat dissipation efficiency.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 illustrates a perspective view of a motor structure according to an embodiment of the present disclosure;

FIG. 2 illustrates an exploded of the motor structure in FIG. 1;

FIG. 3 illustrates an exploded view of a rotor and two wind blade sets in FIG. 2;

FIG. 4 illustrates a perspective view of a motor structure according to another embodiment of the present disclosure;

FIG. 5 illustrates an exploded of the motor structure in FIG. 4;

FIG. 6 illustrates a side view of a motor structure according to an embodiment of the present disclosure; and

FIG. 7 illustrates a side view of a motor structure according to another embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

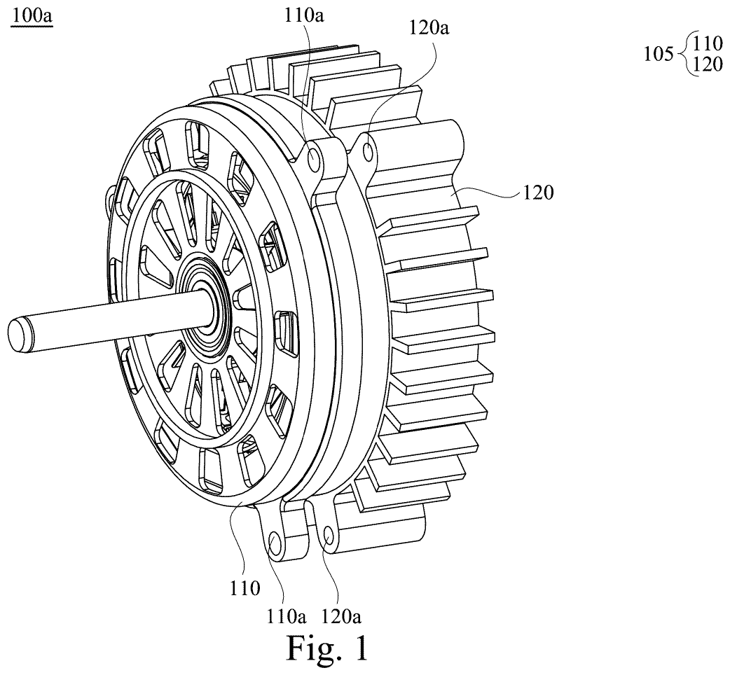

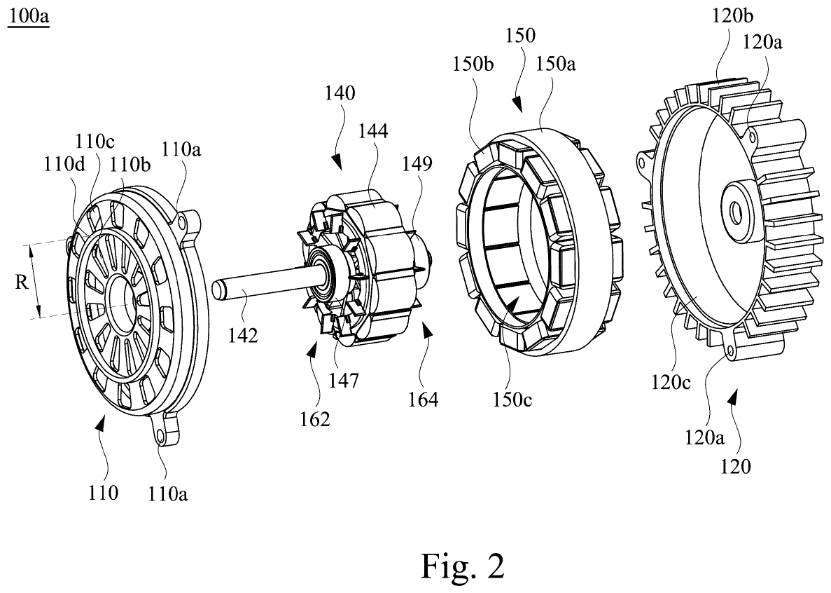

Reference is made to FIG. 1 and FIG. 2. FIG. 1 illustrates a perspective view of a motor structure according to an embodiment of the present disclosure, and FIG. 2 illustrates an exploded of the motor structure in FIG. 1. The motor structure 100a with active heat dissipation function includes a stator ring 150, a rotor 140, two wind blade sets (162, 164) and a thermally-conductive casing 105. The stator ring 150 has a rotor accommodation space 150c located therein. The rotor 140 is located in the rotor accommodation space 150c of the stator ring 150. When an electric current passes through the coil 150b of the stator ring 150, a magnetic field is generated that interacts with the magnet 144 within the rotor 140. When the magnetic field of the stator ring 150 interacts with the magnetic field of the rotor 140, a torque is generated, causing the rotor 140 to rotate. This rotation is based on the magnetic force between the magnetic field generated by the current passing through the coil and the magnet 144 in the rotor.

The two wind blade sets (162, 164) are arranged on two opposite sides of the rotor 140, and rotate synchronously with the rotor 140, and are main components for the active heat dissipation function. A rotating shaft 142 passes through the assembled rotor 140 and two wind blade sets (162, 164), and is rotatably connected to the thermally-conductive cover 110 through a bearing 147, and is rotatably connected to the thermally-conductive cover 120 by a bearing 149. Therefore, the rotor 140 can rotate relative to the thermally-conductive cover 110 and the thermally-conductive cover 120 by means of the rotating shaft 142. In the embodiment of FIG. 2, the motor structure 100a is configured with two wind blade sets (162, 164) on two opposite sides of the rotor 140. In other embodiments, the motor structure may include only a single wind blade set (e.g., the wind blade set 162) on one side of the rotor 140.

The stator ring 150 includes an annular body 150a and a plurality of coils 150b, and forms a rotor accommodation space 150c therein. When the motor structure 100a is assembled, an annular outer wall of the annular body 150a contacts an annular inner wall 120c of the thermally-conductive cover 120, and can be fixed by thermally-conductive glue or a tight fit between the outer wall and the inner wall. When the motor structure 100a is operating and the coils 150b are energized, part of the electrical energy will be dissipated in the form of heat energy due to resistance. The heat energy can be transferred to the thermally-conductive cover 120 through the annular body 150a, and be accelerated to dissipate through a plurality of heat dissipation fins 120b, which is a passive heat dissipation function. The heat dissipation fins 120b are equally spaced on the annular outer wall of the thermally-conductive cover 120 and extend in a radial direction relative to the rotating shaft 142.

When the motor structure 100a is assembled, the thermally-conductive cover 110 and the thermally-conductive cover 120 are assembled to form a thermally-conductive casing 105 to accommodate the stator ring 150, the rotor 140 and the two wind blade sets (162, 164). The two thermally-conductive covers can be secured to each other through the assembly holes 110a of the thermally-conductive cover 110 and the assembly holes 120a of the thermally-conductive cover 120 using fasteners (not shown in the drawings). The thermally-conductive cover 110 has a plurality of radially-inner holes 110b and a plurality of radially-outer holes 110c. When the motor structure 100a is operating, the rotation of the rotor 140 will drive the two wind blade sets (162, 164), causing the wind blades on them to generate air flow inside the thermally-conductive casing 105. Since the thermally-conductive cover 110 has a plurality of radially-inner holes 110b and a plurality of radially-outer holes 110c, these holes will allow air to pass through and form convection in the thermally-conductive casing 105. As the wind blade set rotates, they will induce airflow in the thermally-conductive casing 105 to promote heat dissipation. This design uses the air flows driven by the rotor 140 and is guided by the holes to circulate the air flows in the thermally-conductive casing 105, effectively improving the heat dissipation efficiency of the motor structure 100a.

On the thermally-conductive cover 110, the radially-inner holes 110b are mainly used as air inlet channels when the wind blade set rotates, and the radially-outer holes 110c are mainly used as air outlet channels. Between the radially-inner holes 110b and the radially-outer holes 110c, the thermally-conductive cover 110 also has a flow-blocking ring 110d to prevent the generation of turbulent flow between the inlet and outlet air. The design of the thermally-conductive cover 120 is different from that of the thermally-conductive cover 110 in that it does not have openings for air inlet and outlet channels, but has heat dissipation fins 120b.

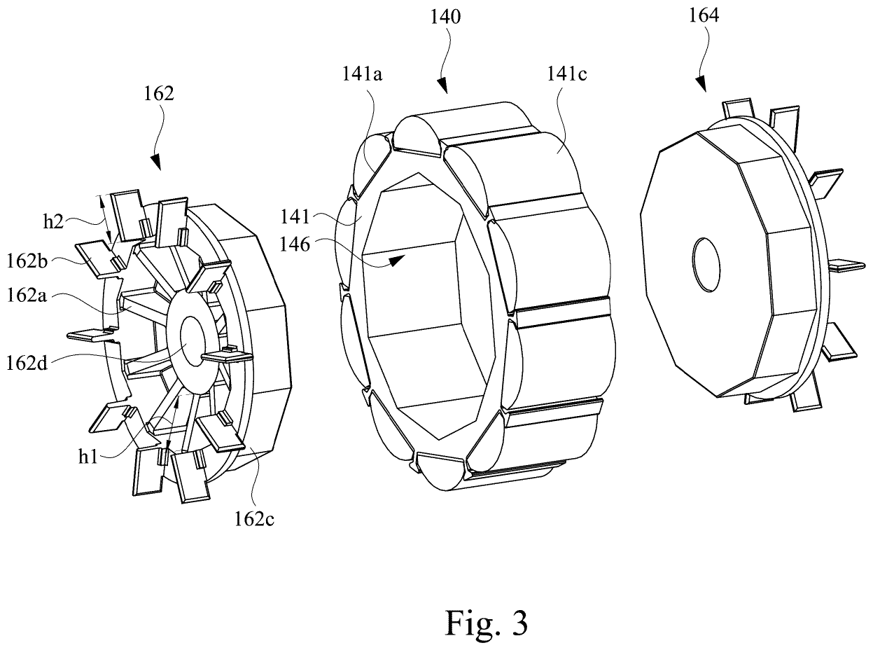

Reference is made to FIGS. 2 and 3. FIG. 3 is an exploded view of the rotor 140 and the two wind blade sets (162, 164) in FIG. 2. The two wind blade sets (162, 164) have the same structural shape and are assembled on the rotor 140 in mirror symmetry. The wind blade set 162 includes a concave disk body 162c, and the concave disk body 162c has a shaft hole 162d for the rotating shaft 142 to pass through. A plurality of radially-inner blades 162a are located in the cavity of the concave disk body 162c, and extend radially outward with the shaft hole 162d as the center. A plurality of radially-outer blades 162b are provided on an outer peripheral edge of the concave disk body 162c, and extend radially outward with the shaft hole 162d as the center.

In some embodiments of the present invention, each radially-inner blade 162a is located radially between two immediately-adjacent radially-outer blades 162b. In some embodiments of the invention, each radially-outer blade 162b is located radially between two immediately-adjacent radially-inner blades 162a. The configuration of these blades helps the introduced air flow to spread smoothly in the radial direction, achieving better heat dissipation efficiency. In some embodiments of the present invention, each radially-inner blade 162a and each radially-outer blade 162b are flat blades. In some embodiments of the present invention, a radial length h1 of each radially-inner blade 162a and a radial length h2 of each radially-outer blade 162b are both smaller than a radius R of the flow-blocking ring 110d, so that the airflow can enter only through the radially-inner hole 110b, does not cause the problem of partial airflow flowing in and out of the radially-outer hole 110c at the same time. The wind blade set 164 has the same structure as the wind blade set 162 and will not be described again.

The rotor 140 includes a rotor body 141 and a plurality of magnets 144. Each magnet 144 is embedded in a magnet slot 141a on the annular outer wall of the rotor body 141. The rotor body 141 also has an accommodation space 146. In some embodiments of the present invention, the two wind blade sets (162, 164) have their polygonal concave disk bodies 162c embedded in a polygonal accommodation space 146 of the rotor body 141. The rotor body 141 usually needs to use materials with good magnetic and mechanical properties. Common choices include magnetic steel, cobalt alloys or iron-silicon alloys. Magnetic steel is an alloy with superior magnetic properties that is suitable for use in rotors because it can effectively hold and conduct magnetic fields. Cobalt alloys, which typically contain cobalt and other metallic elements, have high hysteresis loops and good heat resistance, making them ideal for high-performance motors. Iron-silicon alloys have good magnetic and mechanical properties and are suitable for use in high-performance rotating mechanisms. These materials provide the required magnetic properties when manufacturing the rotor body, while providing sufficient strength and wear resistance to handle long-term operation and other mechanical stresses.

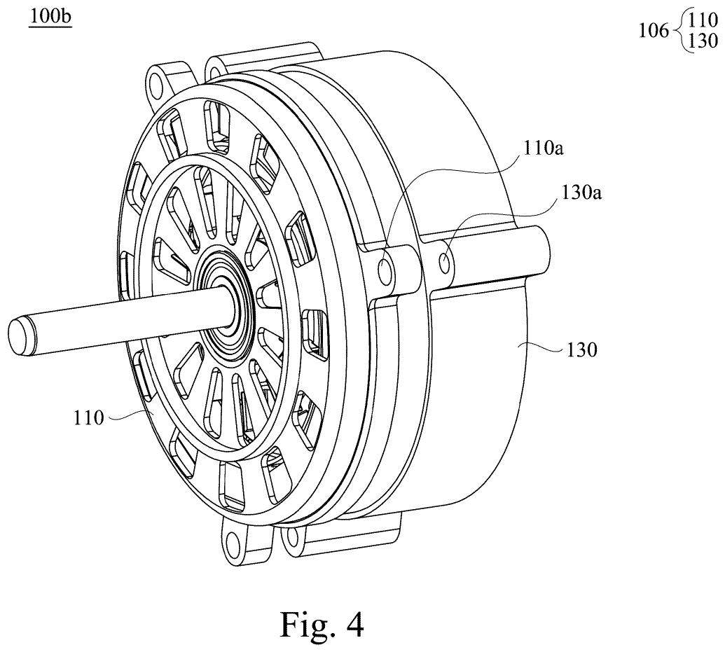

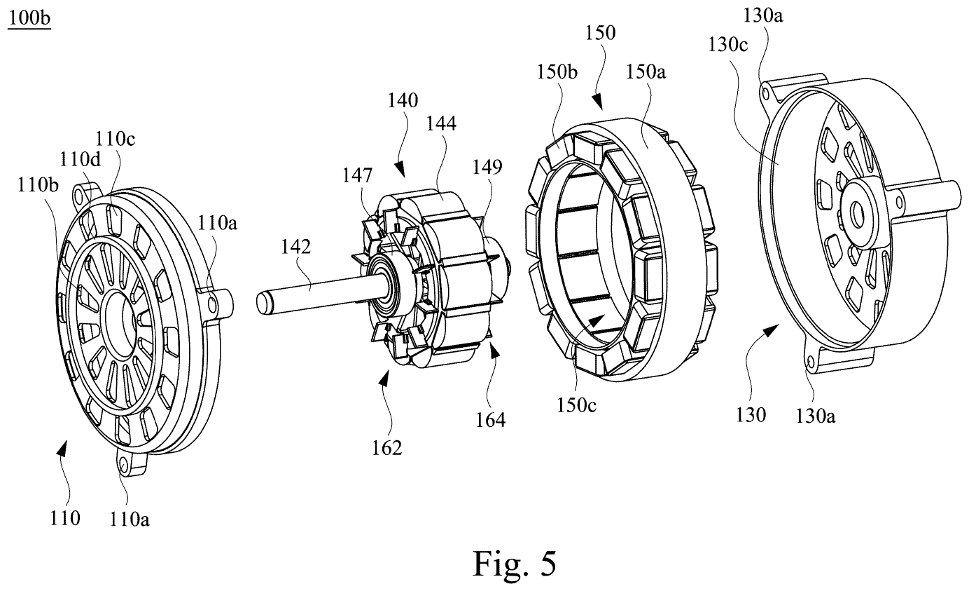

Reference is made to FIG. 4 and FIG. 5. FIG. 4 illustrates a perspective view of a motor structure 100b according to another embodiment of the present disclosure, and FIG. 5 illustrates an exploded of the motor structure 100b in FIG. 4. The motor structure 100b includes a stator ring 150, a rotor 140, two wind blade sets (162, 164) and a thermally-conductive casing 106, but the design of the thermally-conductive casing 106 of the motor structure 100b is different from the thermally-conductive casing 105 of the motor structure 100a. The thermally-conductive casing 106 of the motor structure 100b is composed of a thermally-conductive cover 110 and a thermally-conductive cover 130. When the motor structure 100b is assembled, a fastener (not shown in the figure) is used to lock the two thermally-conductive covers to each other through the assembly hole 110a of the thermally-conductive cover 110 and the assembly hole 130a of the thermally-conductive cover 130. The structure of the thermally-conductive cover 130 is similar to the structure of the thermally-conductive cover 110, and also has the same design as the radially-inner hole 110b, the radially-outer hole 110c and the flow-blocking ring 110d. Therefore, the motor structure 100b can introduce air from both sides of the thermally-conductive casing 106, while the motor structure 100a can only introduce air from one side of the thermally-conductive casing 105 (for example, the side where the thermally-conductive cover 110 is located).

When the motor structure 100b is assembled, the rotating shaft 142 passes through the assembled rotor 140 and the two wind blade sets (162, 164), and is rotatably connected to the thermally-conductive cover 110 through the bearing 147, and is rotatably connected to the thermally-conductive cover 130 through the bearing 149. Therefore, the rotor 140 can rotate relative to the thermally-conductive cover 110 and the thermally-conductive cover 130 by means of the rotating shaft 142. The annular outer wall of the annular body 150a of the stator ring 150 contacts the annular inner wall 130c of the thermally-conductive cover 130, and can be fixed by thermally-conductive glue or a tight fit between the outer wall and the inner wall. When the motor structure 100b is operating, the coils 150b of the stator ring 150 are energized, part of the electrical energy will be dissipated in the form of heat energy due to resistance. The wind blade set 162 and the wind blade set 164 rotated by the rotor 140 can generate air flow inside the thermally-conductive casing 106, and use the radially-inner holes and the radial-outer holes of the thermally-conductive covers 110 and 130 as their air inlet channels and air outlets.

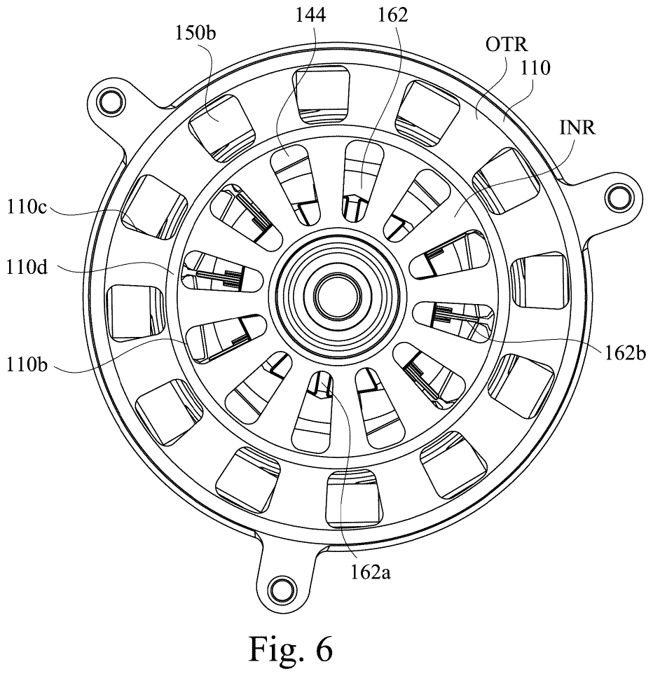

Reference is made to FIG. 6, which illustrates a side view of a motor structure (100a, 100b) form the thermally-conductive cover 110 according to an embodiment of the present disclosure. The thermally-conductive cover 110 includes an outer ring region OTR and an inner ring region INR. The outer ring region OTR and the inner ring region INR are separated by a flow-blocking ring 110d. The inner ring region INR has a plurality of radially-inner holes 110b mainly used as air inlet passages, and the outer ring region OTR has a plurality of radially-outer holes 110c mainly used as air outlet passages. In some embodiments of the invention, an area of a single radially-outer hole 110c is substantially equal to an area of a single radially-inner hole 110b, and a number of radially-outer holes 110c is equal to a number of radially-inner holes 110b, such that the air intake and air outlet can reach a balance for the thermally-conductive cover 110. In some embodiments of the present invention, each radially-inner hole 110b is radially located between two immediately-adjacent radially-outer holes 110c, and/or each radially-outer hole 110c is radially located between two immediately-adjacent radially-inner holes 110b to prevent the generation of turbulent flow between the air inlet and the air outlet.

In some embodiments of the present invention, the inner ring region INR has a plurality of radially-inner holes 110b axially aligned with the wind blade set 162 and the corresponding magnets 144 of the rotor, such that these radially-inner holes 110b serves as the main air intake channel while the wind blade set 162 is rotating. In some embodiments of the present invention, the outer ring region OTR has a plurality of radially-outer holes 110c axially aligned with the corresponding coils 150b of the stator ring 150, such that the airflow is directed through these radially-outer holes 110c as the main air outlet channel after cooling the corresponding coils 150b.

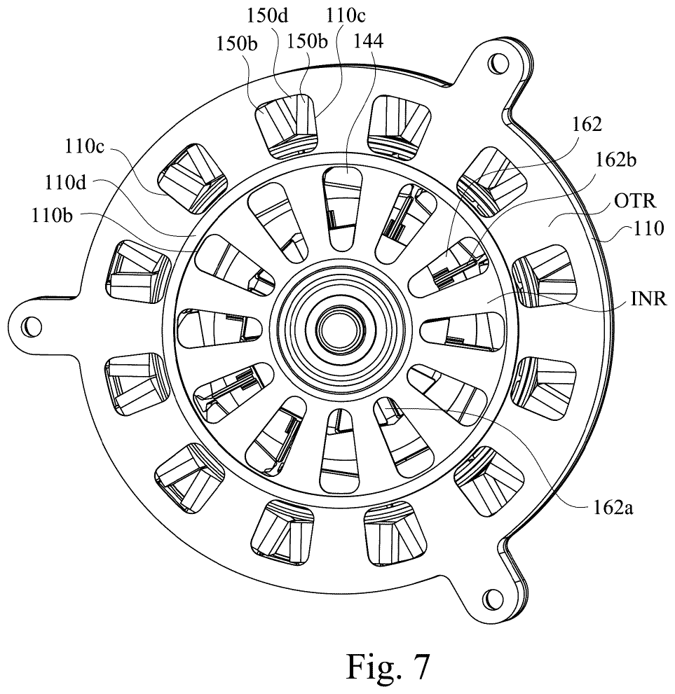

Reference is made to FIG. 7, which illustrates a side view of a motor structure (100a, 100b) form the thermally-conductive cover 110 according to another embodiment of the present disclosure. This embodiment is different from the embodiment of FIG. 6 mainly in the relationship between the radially-outer holes 110c and the coils of the stator ring 150. Specifically, each radially-outer hole 110c is axially aligned with the portions of the corresponding two coils 150b of the stator ring and a gap 150d between the two corresponding coils, such that the air flow can be smoothly discharged from the radially-outer hole 110c.

In sum, the motor structure disclosed here is configured with a wind blade set on the rotor, which induces airflow in the thermally-conductive casing to enhance heat dissipation. At least one of the thermal conductive covers of the thermal-conductive casing can be configured with a radially-inner hole and a radially-outer hole, such that the airflows in and out of the thermally-conductive cover can be smoother, reducing turbulence and improving heat dissipation efficiency.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A motor structure comprising:
a stator ring having a rotor accommodation space;
a rotor disposed within the rotor accommodation space;
a wind blade set disposed on one side of the rotor; and
a thermally-conductive casing enclosing the stator ring, the rotor and the wind blade set, wherein the thermally-conductive casing includes a thermally-conductive cover having a plurality of radially-inner holes and a plurality of radially-outer holes.

2. The motor structure of claim 1, wherein the radially-inner holes are axially aligned with the wind blade set.

3. The motor structure of claim 1, wherein the thermally-conductive cover includes a flow-blocking ring located between the radially-inner holes and the radially-outer holes.

4. The motor structure of claim 3, wherein the wind blade set includes a plurality of blades, and a radial length of each blade is smaller than a radius of the flow-blocking ring.

5. The motor structure of claim 1, wherein each radially-inner hole is radially located between two immediately-adjacent ones of the radially-outer holes, and each radially-outer hole is radially located between two immediately-adjacent ones of the radially-inner holes.

6. The motor structure of claim 1, wherein each radially-outer hole is axially aligned with a corresponding coil of the stator ring.

7. The motor structure of claim 1, wherein each radially-outer hole is axially aligned with portions of two corresponding coils of the stator ring and a gap between the two corresponding coils.

8. The motor structure of claim 1, wherein the thermally-conductive casing includes another thermally-conductive cover, and the another thermally-conductive cover includes a plurality of heat dissipation fins.

9. A motor structure comprising:
a stator ring having a rotor accommodation space;
a rotor disposed in the rotor accommodation space;
two wind blade sets disposed on two opposite sides of the rotor; and
two thermally-conductive covers are assembled to form a thermally-conductive casing to enclose the stator ring, the rotor and the two wind blade sets, wherein each thermally-conductive cover has a plurality of radially-inner holes and a plurality of radially-outer holes.

10. The motor structure of claim 9, wherein the radially-inner holes are axially aligned with the two wind blade sets, and the radially-outer holes are axially aligned with corresponding coils of the stator ring.

11. The motor structure of claim 9, wherein each thermally-conductive cover includes a flow-blocking ring located between the radially-inner holes and the radially-outer holes.

12. The motor structure of claim 11, wherein each wind blade set includes a plurality of blades, and a radial length of each blade is smaller than a radius of the flow-blocking ring.

13. The motor structure of claim 11, wherein each wind blade set includes a plurality of radially-inner blades and a plurality of radially-outer blades, and radial lengths of all the radially-inner blades and the radially-outer blades are smaller than a radius of the flow-blocking ring.

14. The motor structure of claim 9, wherein each radially-inner hole is radially located between two immediately-adjacent ones of the radially-outer holes, and each radially-outer hole is radially located between two immediately-adjacent ones of the radially-inner holes.

15. The motor structure of claim 9, wherein each radially-outer hole is axially aligned with portions of two corresponding coils of the stator ring and a gap between the two corresponding coils.
